(19) United States
(12) Patent Application Publication
(10) Pub. No.: US 2007/0278098 A1
(43) Pub. Date: Dec. 6, 2007

(54) Gas sensor and gas detection system using the same

(75) Inventors: Koichi Yokosawa, Kokubunji (JP); Sadaki Nakano, Kokubunji (JP); Yasushi Goto, Kokubunji (JP)

Correspondence Address: Stanley P. Fisher;Reed Smith LLP, Suite 1400, 3110 Fairview Park Drive, Fallschurch, VA, 22042-4503, US

(73) Assignee: Hitachi, Ltd.

(21) Appl. No.: 11/806,806

(22) Filed: Jun. 4, 2007

(30) Foreign Application Priority Data
Jun. 5, 2006 (JP) 2006-155829

(51) Int. Cl. G01N 27/26

(52) U.S. Cl. 204/431

(57) ABSTRACT

It is an object of the present invention to minimize the power for heating of an FET-type gas sensor using an FET to ensure a long operating life.

Two terminals 10 and 11 are arranged at a sensitive electrode 31 formed on a gate insulation film of an FET, and different potentials are applied thereto to cause a current to flow. The sensitive electrode 31 functions as a heating element by causing a current to flow in the sensitive electrode 31 which needs to be heated, allowing the FET-type gas sensor to be heated most efficiently. Furthermore, the terminals 10 and 11 configure a part of a temperature detector which measures the temperature of the heated sensitive electrode 31.

### CLAIM OF PRIORITY

The present application claims priority from Japanese application JP 2006-155829 filed on Jun. 5, 2006, the content of which is hereby incorporated by reference into this application.

### BACKGROUND OF THE INVENTION

1. Field of the Invention

The present invention relates to a gas sensor which uses a field effect transistor and a gas detection system using this gas sensor. More particularly, the present invention is concerned with a sensor having low power consumption and a long operating life and a gas detection system which can identify the type of a gas.

2. Description of the Related Art

There are various types of gas sensors; for example, a contact combustion type, a semiconductor type, a thermal conduction type, an infrared absorption type, etc. which are known as an inflammable gas sensor. Furthermore, as a system using a thin film or a thick film, a field effect transistor (hereafter referred to as an FET) type (wherein a film of sensitive electrode is formed on a gate electrode of the FET and change of a gate potential by a target gas is read out by the FET) is proposed on pages 15 to 20 of “Sensors and Actuators, Vol. B1 (1990).” A thermoelectric type (wherein a temperature rise of a thermoelectric conversion film by a target gas is read out as voltage) is proposed on pages L1232 to L1234 of “Japanese Journal of Applied Physics Vol. 40 (2001).”

Almost all gas sensors are heated to about 100° C. to 400° C. in order to promote electrochemical reaction. Also in the case of the FET type, an element with an FET formed thereon is entirely heated or a periphery of the FET is locally heated so that an FET portion be maintained at a constant temperature of about 100° C. in many cases. This configuration is effective for eliminating influence of the temperature of the sensitive electrode on electrical characteristics of the FET and increasing the response speed, as described on pages 159 to 162 of “The 4th IEEE Conference on Sensors.”

In the case of an FET-type gas sensor, a portion to be heated is the sensitive electrode formed on a gate insulation film of the FET. Then, some configurations for arranging a heater near the sensitive electrode are known. For example, JP-A-9-218172 discloses an FET sensor having a gate electrode used as a sensitive electrode which has an exposed surface and extends toward the outside of the source and drain electrodes and a heating section arranged at the gate electrode through an insulation film. Furthermore, in JP-A-9-329576, a heater is arranged on the gate electrode in order to uniformly control the temperature of the gate electrode and improve the response time and sensitivity of the sensor. The sensor disclosed in JP-A-9-329576 measures both a surface potential and electrical impedance of the gate electrode. Therefore, JP-A-9-329576 discloses an FET structure for reading the surface potential as well as a method for measuring the electrical impedance by directly connecting the electrical connecting section to the gate electrode to turn on the gate electrode.

Furthermore, identification of gas type is also an important subject for a gas sensor. A sensor material which reacts only to a specific gas type is currently under development. However, as described on pages 144 to 145 of “The 10th International Meeting on Chemical Sensors and Technical Digest” for example, a method for changing the sensor temperature into a sinusoidal form through heating control of a sensor and estimating gas type from a phase difference between the temperature and the sensor output is proposed as a method for heating a sensor and related technology.

In order to obtain quick response speed while restraining influence of environmental temperature and humidity, it is necessary to heat a gas sensor. On the other hand, when a battery is used as a power supply for the sensor, there is also a conflicting demand for minimizing the power consumption of the sensor. Furthermore, when quickly heating a sensor at room temperature or when changing the sensor temperature in time to identify gas type, there is also a demand for improving the temperature response of the sensor in response to heating.

### SUMMARY OF THE INVENTION

An object of the present invention is to provide an FET-type gas sensor which minimizes the power consumption at the time of heating, and further provide a gas sensor and a gas detection system which improve the response of sensor temperature at the time of heating and enable identification of gas type.

In order to attain the above-mentioned object, the present invention provides a gas sensor using an FET wherein the gate potential changes depending on the concentration of gas. The gas sensor comprises: a gate insulation film formed on a channel region between a source and a drain; a sensitive electrode located on this gate insulation film; two terminals connected to this sensitive electrode which are used to cause a heating current to flow in the sensitive electrode by applying different potentials thereto to raise the temperature thereof; and a temperature detector which detects the temperature of the sensitive electrode. Furthermore, the present invention provides an FET-type gas sensor wherein the gate potential changes depending on the concentration of gas. The FET-type gas sensor comprises: a source electrode and a drain electrode which are respectively connected to the source and the drain; a gate insulation film formed on a channel region between the drain and the drain; a sensitive electrode located on the gate insulation film; two terminals connected to the sensitive electrode which are used to cause a current to flow in the sensitive electrode to raise the temperature thereof; and a temperature detector which includes a diode which is formed on the same substrate as the FET and detects the temperature of the sensitive electrode.

Furthermore, the present invention provides a gas detection system which detects the concentration of gas. The gas detection system comprises: at least one FET-type gas sensor including a gate insulation film formed on a channel region between the source and the drain, a sensitive electrode located on the gate insulation film, two terminals connected to the sensitive electrode which are used to cause a current to flow in the sensitive electrode to raise the temperature thereof, and a temperature detector which detects the temperature of the sensitive electrode; a heat controller which controls potentials applied to these terminals of the gas sensor; a temperature readout circuit connected to the temperature detector; an output readout circuit connected to the source and drain of the gas sensor; and a control unit to which the heat controller, the temperature readout circuit, and the output readout circuit are commonly connected.

A plurality of terminals are connected to the sensitive electrode. By causing a current to flow by use of the heat controller connected to these terminals, the sensitive electrode itself is used as a heating element or a heater to raise the temperature thereof to about 50° C. or higher, preferably about 100° C. In this manner, the temperature of the heated sensitive electrode is detected by the temperature detector. The configuration of the sensitive electrode of the present invention is such that the gate electrode itself is formed as a single or a plurality of layers of sensitive film or a sensitive film is formed on the gate electrode. Furthermore, the sensitive electrode may be formed not only on the gate insulation film but also on a portion other than the gate insulation film.

In accordance with the present invention, since the heating element is identical to a portion to be heated, the heat capacity of the portion to be heated is minimized, making it possible to remarkably reduce the power for heating. Specifically, in the case of an FET-type gas sensor, since it is sufficient that the sensitive electrode on the gate insulation film is heated, the sensitive electrode can be heated directly and sufficiently by causing a heating current to flow between the two terminals connected to the sensitive electrode, thus ensuring the reduction of the power consumption. Furthermore, because of quick temperature response of the sensor in response to heating, it is also possible to identify gas type using temperature variation of the sensitive electrode.

### BRIEF DESCRIPTION OF THE DRAWINGS

FIG. 1 is a diagram showing an equivalent circuit of a gas sensor of a first embodiment of the present invention.

FIG. 2 is a diagram showing an equivalent circuit of a gas sensor of a second embodiment of the present invention.

FIG. 3 is a diagram showing an equivalent circuit of a gas sensor of a third embodiment of the present invention.

FIG. 4 is a diagram showing an equivalent circuit of a gas sensor of a fourth embodiment of the present invention.

FIG. 5 is a diagram showing an equivalent circuit of a gas sensor of a fifth embodiment of the present invention.

FIG. 6 is a diagram showing an equivalent circuit of a gas sensor of a sixth embodiment of the present invention.

FIG. 7 is a diagram showing an equivalent circuit of a gas sensor of a seventh embodiment of the present invention.

FIG. 8 is a diagram showing an equivalent circuit of a gas sensor with heater having a conventional structure.

FIG. 9 is a plan view showing an example of a configuration corresponding to an equivalent circuit of a gas sensor of the embodiment of the present invention shown in FIG. 7.

FIG. 10 is a diagram showing a structure of a gas sensor of the third embodiment of the present invention.

FIG. 11 is a diagram showing a structure of a gas sensor of the fifth embodiment of the present invention.

FIG. 12 is a diagram showing an embodiment of a cross-sectional configuration of a gas sensor of the present invention, and an ellipse is a schematic cross-sectional view showing a portion of an FET sensor taken along the A-A′ line of FIG. 9.

FIG. 13 is a diagram showing an embodiment of a cross-sectional configuration of a gas sensor of the present invention, and a schematic cross-sectional view showing a portion of a diode thermometer 50 taken along the B-B′ line of FIG. 9.

FIG. 14 is a diagram showing another embodiment of a cross-sectional configuration of a gas sensor of the present invention, and a schematic cross-sectional view showing a portion of the diode thermometer 50 taken along the B-B′ line of FIG. 9.

FIG. 15 is a diagram showing an embodiment of a gas detection system of the present invention.

### DESCRIPTION OF PREFERRED EMBODIMENTS

An embodiment of an FET-type gas sensor and a gas detection system of the present invention will be described in detail with reference to the accompanying drawings.

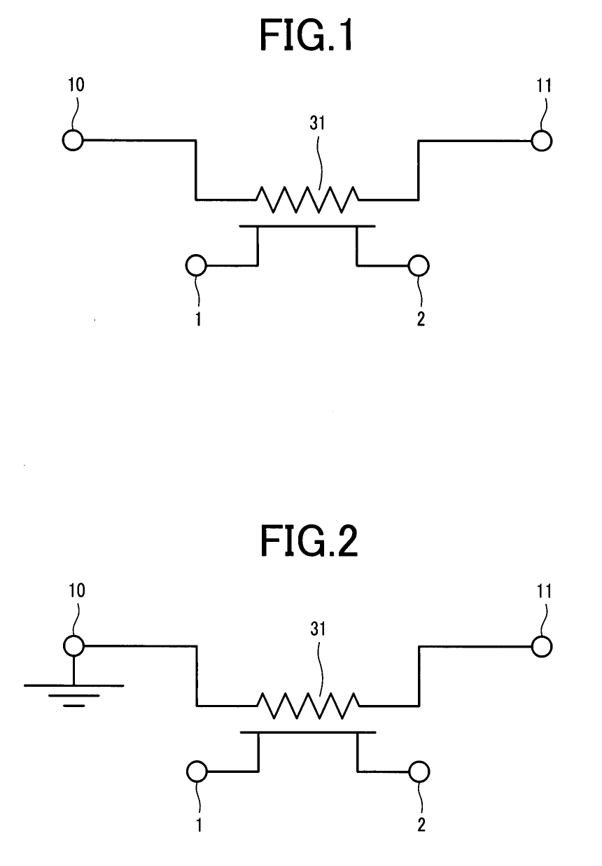

FIGS. 1 to 7 are diagrams showing equivalent circuits of an FET-type gas sensor according to various embodiments of the present invention. FIG. 8 is a diagram for comparison, showing an equivalent circuit having a configuration of a conventional FET-type gas sensor with heater.

First, with a conventional configuration shown in FIG. 8, a heater 4 and a sensitive electrode 3 are electrically independent of each other regardless of where the heater 4 is arranged. Although a terminal for applying a gate potential is connected to the sensitive electrode 3, the potential of the sensitive electrode 3 is maintained at a certain constant value and therefore no heating current flows in the gate to be used as a sensitive electrode.

On the other hand, with a configuration of the embodiment of the present invention, a heating current flows in the gate to be used as a sensitive electrode. FIG. 1 is an equivalent circuit diagram of a first embodiment. With the structure of the first embodiment of FIG. 1, terminals 10 and 11 for heating are connected to a sensitive electrode 31. Since different potentials are applied to the terminals 10 and 11 and a heating current flows in the sensitive electrode 31, the entire portion of the sensitive electrode 31 becomes a heating element. Furthermore, these terminals 10 and 11 may configure a part of a temperature detector as explained later. Terminals 1 and 2 indicate a source electrode (terminal) and a drain electrode (terminal) which are respectively connected to the source and the drain of the FET which configures the FET-type gas sensor. The source electrode 1 and the drain electrode 2 are connected to a readout circuit of an FET output explained later, and used to read out the concentration of gas based on variation of electrical characteristics of the FET output.

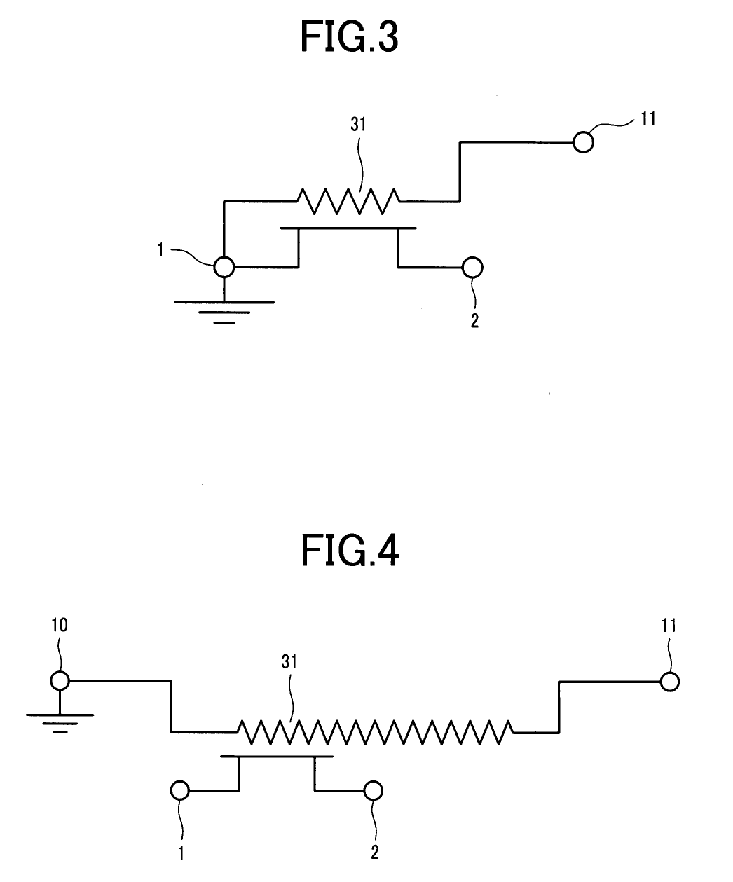

In a second embodiment of FIG. 2, one of the terminals 10 and 11, for example the terminal 10, has a structure common to a ground electrode of the readout circuit. Like a third embodiment of FIG. 3, when the source electrode 1 of the FET is grounded, the configuration can be made simpler by connecting the terminal 10 to the source electrode 1. In the case of configurations of FIG. 1 to FIG. 3, the entire portion of the sensitive electrode 31 functions as a heating element and therefore the same potential distribution as a potential difference between the terminals 10 and 11 arises at the gate of FET. When the terminal 10 is grounded, a potential for heating control is applied to the terminal 11.

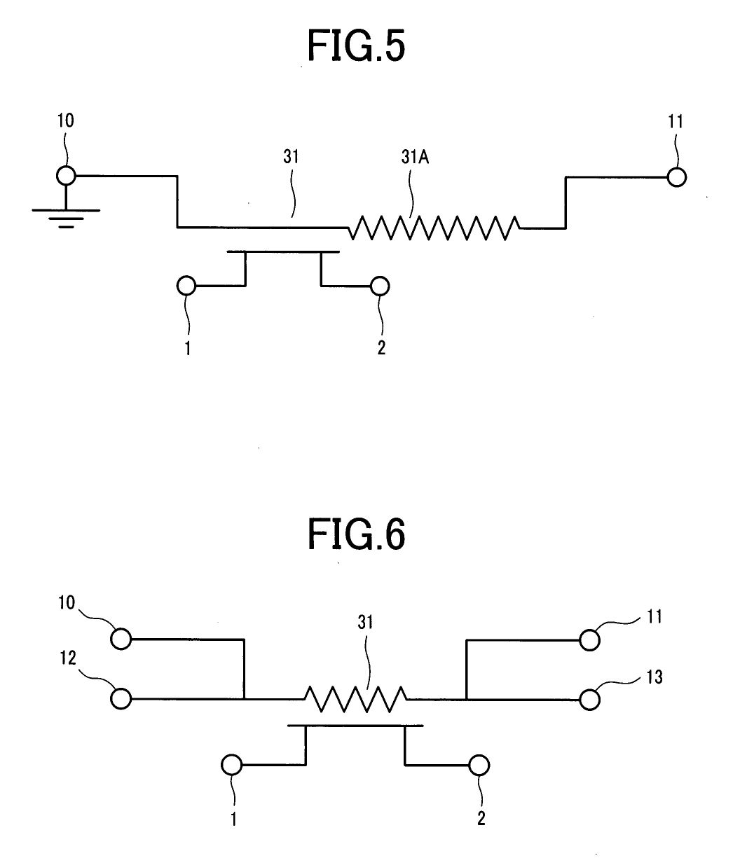

In the case of that it is desirable that little potential distribution arises on the gate potential from the viewpoint of FET characteristics, the configurations of fourth and fifth embodiments shown respectively in FIG. 4 and FIG. 5 are effective. Like a fourth embodiment of FIG. 4, when a part of the heating element of the sensitive electrode 31 is located on the gate insulation film, the sensor can be configured so that only a part of a potential difference necessary for heat generation may affect the gate potential. Furthermore, like a fifth embodiment of FIG. 5, the position of a heating element 31A of the sensitive electrode 31 may be shifted from the position of the gate insulation film so as to heat the sensitive electrode 31 on the gate insulation film through thermal conduction. With both configurations of FIG. 4 and FIG. 5, a heating current flows in the sensitive electrode 31 on the gate insulation film.

The temperature detector is necessary to detect and control the temperature of the FET-type gas sensor in the present embodiment. As this temperature detector, a resistance thermometer is configured using the sensitive electrode itself or a sensor for thermometer, such as a diode, formed on the same substrate is used. In the latter case, the sensitive electrode is flatted for film formation not only on the gate insulation film but also above or below a sensor for thermometer, such as a diode, allowing direct monitoring of the temperature of the sensitive electrode, as later mentioned in detail.

First, a simplest temperature detector using the sensitive electrode itself as a resistance thermometer will be explained below. The temperature of the sensitive electrode 31 is calculated based on a current flowing from two terminals 10 and 11 to the sensitive electrode 31 and a ratio of the potentials of the terminals 10 and 11. Calculation processing is performed with a temperature readout circuit mentioned later. As long as a resistance of the sensitive electrode 31 is large enough in comparison with wiring, two terminals 10 and 11 may be used as a temperature detector like the embodiments shown in FIG. 1 to FIG. 5.

When using a resistance thermometer, the sixth embodiment of FIG. 6 is suitable for measuring temperature more correctly. Specifically, as shown in FIG. 6, terminals 12 and 13 are prepared in addition to the terminals 10 and 11 at the sensitive electrode 31. One pair of the two terminals 10 and 11 is used for current application like the above-mentioned embodiments, and the other pair of the two terminals 12 and 13 is used to measure a potential difference. This configuration makes it possible to measure more correctly only the resistance of the sensitive electrode, thus enabling accurate temperature detection.

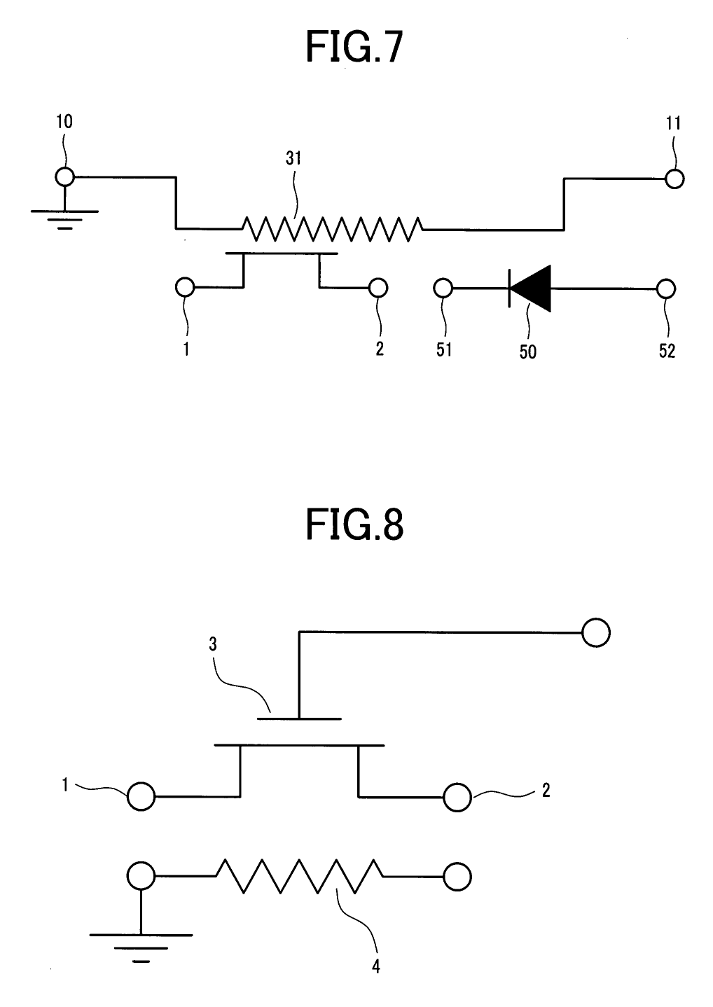

Then, a seventh embodiment will be explained below. The temperature detector of the gas sensor includes a sensor for thermometer formed on the same substrate as the gas sensor, separately from the sensitive electrode 31. An equivalent circuit diagram of the seventh embodiment using a sensor for thermometer composed of a diode as a temperature detector is shown in FIG. 7. In FIG. 7, numeral 50 indicates a diode and numerals 51 and 52 indicate terminals of the diode 50. Other circuit configuration is the same as that for the equivalent circuit shown in FIG. 4. Of course, it would be possible to combine other circuit block diagrams shown in FIG. 1 to FIG. 3 and FIG. 5 with a sensor for thermometer composed of a diode.

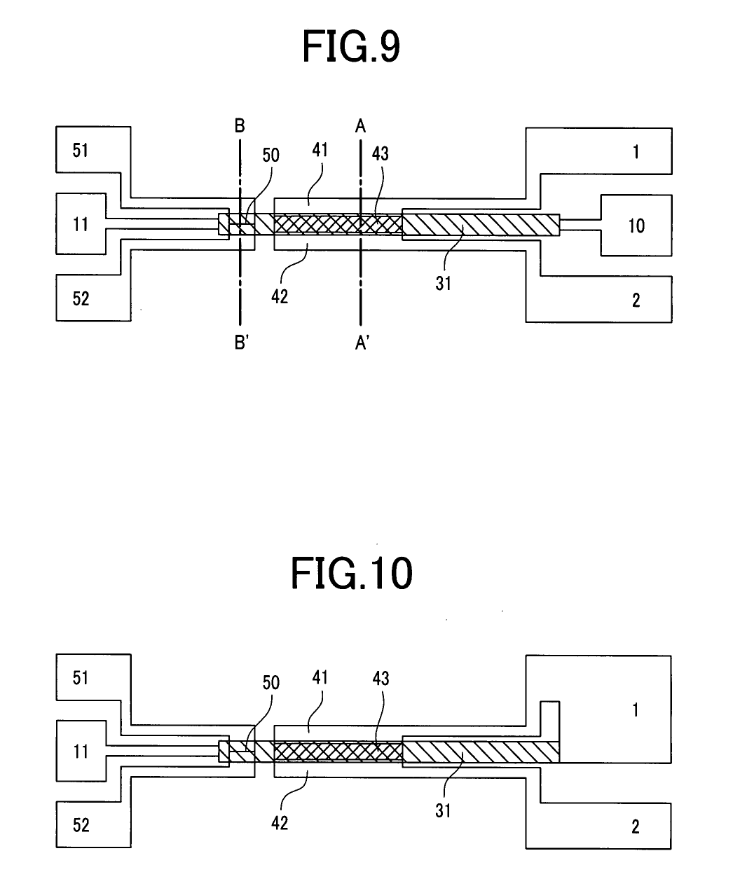

A substrate configuration of the gas sensor of the embodiment of FIG. 7 will be explained with reference to a plan view of FIG. 9. FIG. 9 shows a planar configuration of the entire circuit element of the gas sensor. In FIG. 9, a gate insulation film 43 is located between a source 41 and a drain 42 of an FET. The diode 50 which is a sensor for thermometer is arranged near the FET, on an extension in width direction of the channel region of the FET. The sensitive electrode 31 which is a temperature-heating element is formed so as to cover the gate insulation film 43 and the diode 50 arranged near the FET. The source electrode 1 and the drain electrode 2 are respectively connected to the source 41 and the drain 42 and output a signal which is corresponding to the concentration of gas of the FET-type gas sensor. Electrodes 51 and 52 are connected to the diode 50.

As illustrated in FIG. 9., the terminals 10 and 11 used for potential application are formed at both ends of the sensitive electrode 31 which is a heating element extending in width direction of the channel. With a configuration for measuring the temperature of the sensitive electrode by use of a sensor for thermometer, such as a diode, a thin insulation film is required between the sensitive electrode and the thermometer, and a slight difference in temperature arises. A cross-sectional structure thereof will be illustrated later. However, since the diode has higher reliability and reproducibility as a thermometer, the seventh embodiment can realize an FET-type gas sensor having a practical configuration. This diode is formed by the same process as ordinary diodes.

A specific example of the sensitive electrode 31 in each of the above-mentioned embodiments will be explained below. A material of the sensitive electrode depends on a target gas type. In the case of hydrogen detection, for example, palladium, platinum, or an alloy containing palladium and platinum is frequently used. The thickness of catalyst metal is generally about 100 nm or less and the width thereof is slightly larger than the length of the gate insulation film, for example, several micrometers to several tens of micrometers. Therefore, if the terminals 10 and 11 are arranged so that a current flows in the longitudinal direction of the sensitive electrode 31, i.e., the width direction of the channel region, as shown in the example of FIG. 9, the resistance of the sensitive electrode 31 between the terminals 10 and 11 will become large enough in comparison with wiring.

Therefore, if a voltage is applied to the terminals 10 and 11, the sensitive electrode 31 which is a heating element exclusively generates heat to raise the temperature thereof to about 50° C. or higher, preferably about 100° C. Furthermore, the temperature of the diode 500 becomes almost the same as that of the FET. If the sensitive electrode 31 is made narrow enough, only a small amount of heat leaks to the substrate, limiting the heated area to the sensitive electrode 31, the gate insulation film, the diodes 50, and the periphery thereof, and enabling efficient heating. For example, if palladium with a thickness of 90 nm, a width of 150 μm, and a length of 1.5 mm is used for the sensitive electrode 31, the resistance will be about 40 ohms at room temperature. Even if the substrate is comparatively large in size, i.e., 7.5 mm×3 mm with a thickness of 0.7 mm, it is possible to heat the FET and periphery thereof to about 100° C. by applying power of about 0.2 W to the sensitive electrode 31 which is a heating element. As a result, the resistance of the sensitive electrode 31 rises up to about 50 ohms.

A configuration of a sensor corresponding to the equivalent circuit diagram of the third embodiment of FIG. 3 is shown in FIG. 10. As illustrated in FIG. 10, the third embodiment differs from the embodiment of FIG. 9 in that the source electrode 1 and one end of the sensitive electrode have been unified.

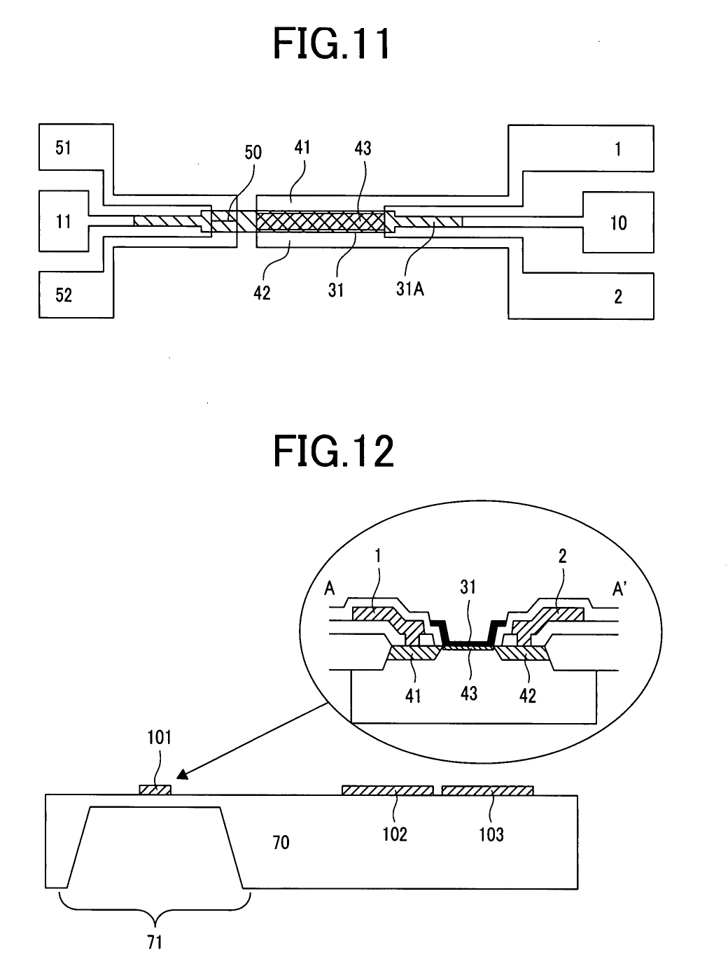

Then, the configuration corresponding to the equivalent circuit diagram of the fifth embodiment of FIG. 5 is shown in FIG. 11. As illustrated in FIG. 11, a portion 31A of the sensitive electrode 31 has been made narrower. Since the resistance becomes higher at a narrower portion, a wide portion of the sensitive electrode 31 on the gate insulation film 43 has a comparatively low resistance and a small voltage gradient. With this configuration, although mainly a narrow portion 31A generates heat as a heating element, the sensitive electrode 31 on the gate insulation film 43 or the diode 50 is also heated through thermal conduction. Although a narrow portion which functions as this heating element 31A may be made of the same material as the sensitive electrode 31, it does not need to function as a sensitive film and therefore covering the surface thereof with an insulation film arises no problem.

Each of FIG. 12 to FIG. 14 is a diagram showing an example cross-sectional configuration of the above-mentioned embodiments of the present invention. FIG. 12 shows an embodiment wherein a gas sensor 101 having an FET and a diode, a readout circuit 102, and an A/D (analog/digital) converter 103 are formed on a silicon substrate 70. Backside etching 71 is performed directly under the gas sensor 101 to be heated, allowing more efficient heating. An ellipse of FIG. 12 shows a schematic cross-sectional view of an FET-type gas sensor. This diagram is a cross-sectional view of a portion corresponding to a cross-section A-A′ in the plan view of the embodiment of the gas sensor of FIG. 9. The sensitive electrode 31 which is a heating element is formed on the gate insulation film 43 located between the source 41 and the drain 42. This sensor is manufactured by use of an ordinary semiconductor process. The material of the sensitive electrode 31 is differentiated depending on a target gas type as mentioned above.

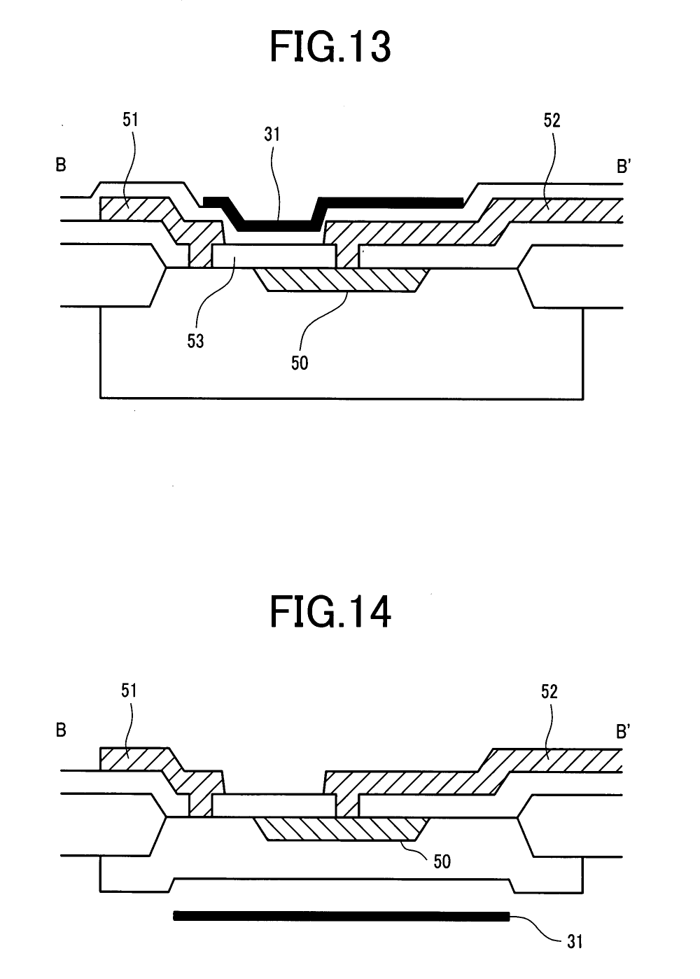

Likewise, each of FIG. 13 and FIG. 14 is a schematic cross-sectional view of an embodiment of the portion of diode 50 which configures a temperature detector of the FET-type gas sensor. This diagram is a schematic cross-sectional view corresponding to a cross-section B-B′ of the gas sensor of FIG. 9. An embodiment of FIG. 13 is configured so that the sensitive electrode 31 which is a heating element is located, through an insulation film 53, above the diode 50 formed in the substrate. An embodiment of FIG. 14 is configured so that the sensitive electrode 31 which is a heating element is located below the diode 50. At the portion of the diode, the sensitive electrode functions as a heating element and does not need to function as a sensitive electrode nor be exposed to the atmosphere. Therefore, as shown in FIG. 14, the sensitive electrode may be located inside the substrate.

As illustrated in above-mentioned various embodiments of gas sensor, the sensitive electrode itself is used as a heating element or a heater by forming at least two terminals in the sensitive electrode and causing a heating current to flow from the heat controller to these terminals. Therefore, although the sensitive electrode of the FET-type gas sensor will function as a heating element, it is not necessary that the entire portion of the sensitive electrode is a heating element as mentioned above. It is also not necessary that the entire portion of the sensitive electrode has a gas sensitive function. In other words, it is preferable that at least a part of the sensitive electrode functions as a heating element and that at least a part of the sensitive electrode is configured so as to be exposed to the atmosphere to exhibit a gas sensitive function.

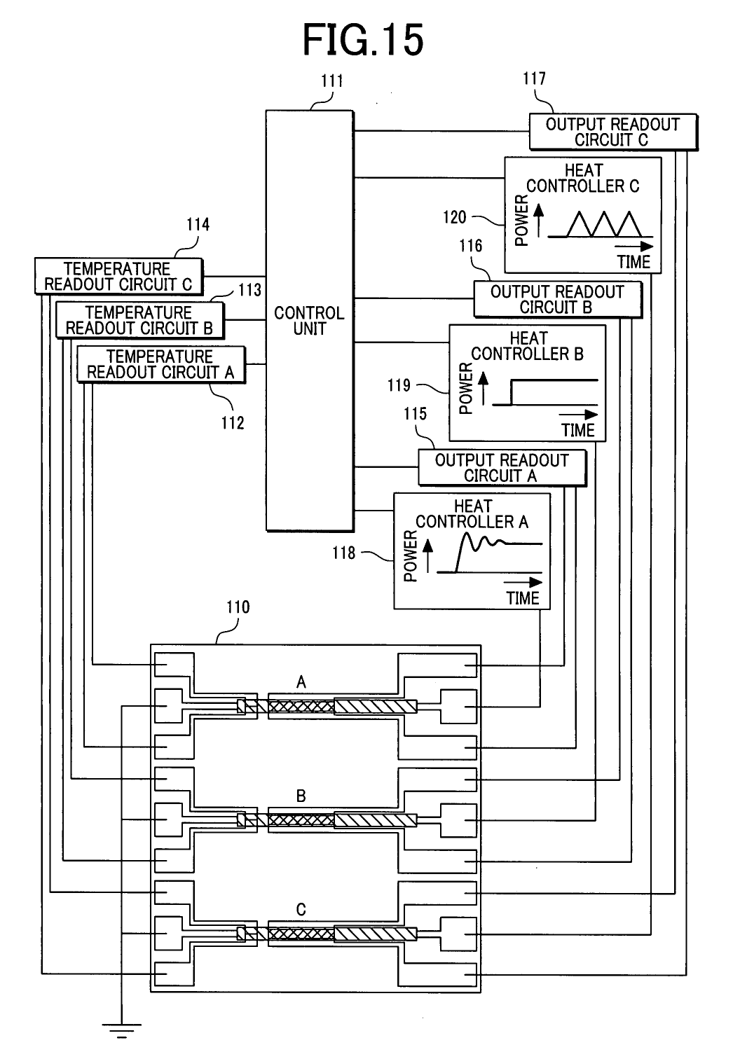

An embodiment of a gas detection system using the above-mentioned gas sensors will be explained with reference to FIG. 15. Although a gas sensor to be used includes for example a combination of the FET-type gas sensor and the diode of the embodiment of FIG. 9, it goes without saying that a structure of other embodiments may be used. Furthermore, although three gas sensors are used for example, any number of gas sensors can be used. The number of gas sensors is determined by the number of gas types to be detected.

As illustrated in FIG. 15, the present embodiment includes three gas sensors A, B, and C formed on a same silicon substrate 110. Temperature readout circuits A 112, B 113, and C 114; FET output readout circuits A 115, B 116, and C 117; and heat controllers A 118, B 119, and C 120 are connected to each of the gas sensors. Each of the FET output readout circuits A 115, B 116, and C 117 detects the concentration of gas from variation of electrical characteristics of the FET output.

These circuits and devices are connected to a common control unit 111 and controlled by this control unit 111. Specifically, efficient control is enabled by controlling all of the heat controllers, the output readout circuits which read the output of the FET-type gas sensor, and the temperature readout circuits by means of a unified control unit. The control unit 111 includes a controller using, for example, a microcomputer chip, etc. Although not illustrated, an A/D converter is installed as required at each interface with the readout circuits 112 to 117, the heat controllers 118 to 120, and the control circuit 111. Each of the heat controllers A 118, B 119, and C 120 is connected to terminals formed at the sensitive electrode of each of the gas sensors A, B, and C, respectively, to perform heating control. Furthermore, each of the temperature readout circuits A, B, and C is connected to a pair of terminals of the diode of each of the gas sensors A, B, and C, respectively, to configure a temperature detector.

With a gas detection system having a configuration of the present embodiment, if the structures near the sensitive electrodes of the FETs of the gas sensors A, B, and C are different from each other, a difference in each output of the FETs can be processed with the control unit 111, enabling identification of the gas type. For example, on the premise that palladium (Pd) is used for the sensitive electrodes of all the FETs, the gas sensor A uses palladium, the gas sensor B is configured so that a fluoro-ion-exchange resin with a thickness of about 1 μs is inserted between palladium and a gate insulation film, and the gas sensor C is configured so that yttria-stabilized zirconia (YSZ) with a thickness of about 1 μs is inserted between palladium and a gate insulation film. The gas sensor B has a high selectivity to hydrogen gas and the gas sensor C has a high response to oxygen, making it easier to discriminate hydrogen gas from methane, ethane, and carbon monoxide.

Furthermore, it is also possible to utilize the fact that follow-up characteristics of the FET output with respect to temperature variation of the FET differ from each gas type. Specifically, even if the gas sensors A, B, and C are provided with completely the same FET configuration, identification of the gas type is enabled by differentiating heating control as schematically shown in a frame of each of the heat controllers A 118, B 119, and C 120 of FIG. 15. The heating control can be differentiated by varying the power applied to a heating element of each gas sensor. Such control of the power output from each heat controller is realized through control of the control unit 111.

Follow-up characteristics of the FET output with respect to temperature variation of the FET depend on both the type and the concentration of gas. For example, for the sensor of the gas sensor A, PID (Proportional, Integral, and Differential) control is performed as schematically shown in the heat controller A 118 so that a certain constant temperature be reached as early as possible to maintain the certain constant temperature, allowing the concentration of gas to be determined based on a saturation value of the gas sensor output. Furthermore, for the sensor of the gas sensor B, the power applied to the corresponding heating element is controlled as schematically shown in the heat controller B 119 to quickly heat the heating element so as to measure follow-up characteristics of the sensor output. Furthermore, for the sensor of the gas sensor C, the temperature is periodically fluctuated as schematically shown in the heat controller C 120 so as to measure a phase lag of the output, allowing identification of the gas type.

As illustrated in FIG. 15, since the heating area is limited to the sensitive electrode which functions as a heating element of each sensor in accordance with the structure of the present embodiment, each FET is virtually thermally separated resulting in quick temperature response of each FET. Furthermore, by detecting the temperature of this sensitive electrode by means of a temperature detector including a diode and temperature readout circuits 112 to 113, separation of gas types using temperature variation can be performed in a short period of time.

Although various embodiments of gas sensors and gas detection systems have been described in detail above, it goes without saying that the present invention is not limited to the above-mentioned embodiments. It is expected that a detection system which not only measures the concentration of gas at a particular position like the above-mentioned embodiments but also measures the concentration distribution of gas over the entire facility and, using this result, monitors leakage diffusion and locates a leakage section will become widely used in the future. However, the above-mentioned embodiments can also be applied to such a detection system.

For example, a hydrogen station where hydrogen gas is supplied to fuel cell electric vehicles is a good example of facilities which need such a detection system because it is built in urban area and therefore a high level of safety is demanded. In order to install a number of gas sensors at arbitrary positions, it is desirable that each sensor be battery-operated and information exchange between each sensor and command-and-display equipment be performed through wireless communication. In this case, it is demanded in particular that a gas sensor provides low power consumption. Furthermore, even when mounting a hydrogen gas sensor on a fuel cell electric vehicle, it is demanded that the power supply is the battery of the car and the gas sensor provides low power consumption. Taking into consideration that leaving the sensor heated for a prolonged period of time may shorten the operating life thereof, the present applicant has developed a technique for maintaining the sensor at room temperature without heating it and, if there is a possibility of gas leakage, turning on the heater of the sensor for quick heating; and disclosed the technique in JP-A-2004-341897 “A Gas Detection System.” The above-mentioned various types of gas sensors can be applied to such a gas detection system.

As illustrated in above-mentioned various embodiments, by causing a heating current to flow in the sensitive electrode, it is possible to use the sensitive electrode as a heating element or a heater and perform temperature control while detecting the temperature of the sensitive electrode by the temperature detector. This makes it possible to remarkably reduce the power for heating and further identify the gas type using temperature variation of the sensitive electrode.

What is claimed is:

1. A gas sensor using a field effect transistor in which a gate potential changes depending on the concentration of a target gas, the gas sensor comprising:
a gate insulation film formed on a channel region between a source and a drain;
a sensitive electrode located on the gate insulation film;
two terminals connected to the sensitive electrode which are used to cause a current flow in the sensitive electrode by applying different potentials thereto to increase the temperature of the sensitive electrode; and
a temperature detector which detects the temperature of the sensitive electrode.

2. The gas sensor according to claim 1, comprising:
a source electrode and a drain electrode which are respectively connected to the source and the drain, wherein
one of the terminals is electrically connected to one of the source and drain electrodes.

3. The gas sensor according to claim 1, wherein
the temperature detector detects a current flowing from the terminals to the sensitive electrode and a potential difference between both ends of the sensitive electrode.

4. The gas sensor according to claim 2, wherein
the temperature detector detects a current flowing from the terminals to the sensitive electrode and a potential difference between both ends of the sensitive electrode.

5. The gas sensor according to claim 3, wherein
the terminals include a first terminal and a second terminal which are connected to one end of the sensitive electrode, and a third terminal and a fourth terminal which are connected to the other end of the sensitive electrode;
a current flows between the first and third terminals; and
the temperature detector detects a potential difference between both ends of the sensitive electrode using the second and fourth terminals.

6. The gas sensor according to claim 4, wherein
the terminals include a first terminal and a second terminal which are connected to one end of the sensitive electrode, and a third terminal and a fourth terminal which are connected to the other end of the sensitive electrode; and
a current flows between the first and third terminals; and
the temperature detector detects a potential difference between both ends of the sensitive electrode using the second and fourth terminals.

7. The gas sensor according to claim 1, wherein
the temperature detector includes a diode formed on the same substrate as the field effect transistor.

8. The gas sensor according to claim 7, wherein
the sensitive electrode is also formed above the diode of the temperature detector through an insulation film.

9. The gas sensor according to claim 7, wherein
the sensitive electrode is also formed below the diode of the temperature detector through an insulation film.

10. The gas sensor according to claim 2, wherein
the temperature detector includes a diode formed on the same substrate as the FET, and the sensitive electrode is also formed above the diode through an insulation film.

11. The gas sensor according to claim 2, wherein
the temperature detector includes a diode formed on the same substrate as the field effect transistor, and the sensitive electrode is also formed below the diode through an insulation film.

12. The gas sensor according to claim 1, wherein
the sensitive electrode is heated so that the temperature thereof becomes 50° C. or higher.

13. The gas sensor according to claim 2, wherein
the sensitive electrode is heated so that the temperature thereof becomes 50° C. or higher.

14. A gas sensor using a field effect transistor wherein a gate potential changes depending on the concentration of a gas, comprising:
a source electrode and a drain electrode which are respectively connected to a source and a drain;
a gate insulation film formed on a channel region between the source and the drain;
a sensitive electrode located on the gate insulation film;
two terminals connected to the sensitive electrode which are used to cause a current to flow in the sensitive electrode to increase the temperature of the sensitive electrode; and
a temperature detector which includes a diode formed on the same substrate as the field effect transistor, and detects the temperature of the sensitive electrode.

15. The gas sensor according to claim 14, wherein
the sensitive electrode is also formed above the diode through an insulation film.

16. The gas sensor according to claim 14, wherein
the sensitive electrode is heated so that the temperature thereof becomes 50° C. or higher.

17. A gas detection system which detects the concentration of a gas, the gas detection system comprising:
a gas sensor which uses a field effect transistor, the gas sensor including a gate insulation film formed on a channel region between a source and a drain, a sensitive electrode located on the gate insulation film, two terminals connected to the sensitive electrode which are used to cause a current to flow in the sensitive electrode by applying different potentials thereto to increase the temperature of the sensitive electrode, and a temperature detector which detects the temperature of the sensitive electrode;
a heat controller which controls the potentials applied to the terminals of the gas sensor;
a temperature readout circuit connected to the temperature detector of the gas sensor;
an output readout circuit connected to the source and the drain of the gas sensor; and
a control unit to which the heat controller, the temperature readout circuit, and the output readout circuit are commonly connected.

18. The gas detection system according to claim 17, wherein
a plurality of gas sensors are provided;
the heat controller, the temperature readout circuit, and the output readout circuit are disposed for each of the plurality of gas sensors; and
the potentials applied to the terminals of each gas sensor are respectively controlled by the corresponding heat controller.

19. The gas detection system according to claim 17, wherein
a plurality of gas sensors are provided and each of the plurality of gas sensors detects a different target gas.
